(19) United States
(12) Patent Application Publication
(10) Pub. No.: US 2009/0043031 A1
(43) Pub. Date: Feb. 12, 2009

(54) Compatibilized multipolymer composition containing particulate filler

(76) Inventors: Keith William Pollak, Lewiston, NY (US); Clyde Spencer Hutchins, Colden, NY (US); Jennifer Leigh Thompson, Williamsville, NY (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/890,398

(22) Filed: Aug. 6, 2007

(51) Int. Cl. C08K 3/10; C08G 69/02; C08L 25/00; C08L 27/00; C08L 33/06; C08L 67/00; C08L 73/00; C08L 77/00

(52) U.S. Cl. 524/437; 524/1; 524/551; 524/560; 524/565; 524/577; 524/592; 524/599; 524/601; 524/606; 524/612

(57) ABSTRACT

A precursor composition to formation of a solid composite contains a glassy polymer, a step-growth polymer, a polymer or oligomer which is miscible with the glassy polymer and particulate filler.

### BACKGROUND OF THE INVENTION

1. Field of Invention

The present invention is directed to multipolymer polymer compositions containing a compatibilizer and particulate filler.

2. Description of the Related Art

The use of compatibilizers as interfacial agent in polymer blends is well known. A detailed background is provided in: “Polymer Blends” by D. R. Paul and S, Newman, Volume 1, 2, Academic Press, Inc., 1978.

Also it is known to add non-reactive compatibilizing copolymers to two or more immiscible polymers to improve the strength and toughness of a resultant blended material. Illustratively copolymer compatibilizers may modify melt rheology of immiscible polymers and may lower surface energy of interfaces between the immiscible polymers.

Compatibilizing copolymers may be formed from monomers or polymeric blocks of the immiscible polymers which allows miscibility with each of the immiscible polymers. Two types of synthesis of copolymer compatibilizers are known. A first type is a copolymer synthesized from monomers that comprise the immiscible polymers. The arrangement of monomers within this copolymer conventionally is linear resulting in a structure which can be alternating, random, or blocky. A second type is a copolymer synthesized to impart a chemical functionality of one immiscible polymer and a separate step to introduce at least one constituent of the other immiscible polymer. For example chemical functionality can be introduced by adding one or more monomers which have similar functionality of one immiscible polymer and by grafting one or more segments of a second immiscible polymer. Examples of a resulting copolymer compatibilizer structure include blocky, branched, comb and star. Formation of this type of copolymer compatibilizer requires steps derived from functionalization of a first immiscible polymer and an addition of the segments of a second immiscible polymer.

Typically synthesis of a copolymer compatibilizer is initially undertaken followed by subsequent addition of the compatibilizer to the immiscible polymers.

The use of particulate filler in polymeric compositions for use as a solid surface material is well known in the art. Suitable disclosures include U.S. Pat. Nos. 3,488,246; 3,847,865; and 4,085,246.

U.S. Pat. No. 6,476,111 discloses an extrudable composition containing a glassy polymer, a semi-crystalline polymer, a compatibilizing agent and particulate mineral filler.

There is a need for new compositions containing particulate fillers and which contain at least two polymers which are not inherently compatible with one another.

### SUMMARY OF THE INVENTION

A first embodiment of the invention is directed to a precursor composition for formation of a solid composite which comprises:

(a) a glassy polymer,

(b) a step-growth polymer,

(c) a polymer or oligomer which is miscible with the glassy polymer and

(d) particulate filler.

However further criticality of the first embodiment is with use of a high concentration of (d) particulate filler to form a highly filled composition.

### DETAILED DESCRIPTION OF THE PREFERRED EMBODIMENTS

For formation of a composition which is a precursor to a solid composite a first necessary component is a glassy polymer. As used herein, the term “glassy polymer” refers to an amorphous polymer that exhibits a glass transition temperature (Tg) but not a melt temperature (Tm). Preferably, the glass transition temperature is at least 25 degrees C. A glassy polymer is capable of being repeatedly melt processed in plastic manufacturing machinery and is often considered as a substitute for common glass. The glassy polymer may be formed by known polymerization processes. Glassy polymers include, but are not limited to, acrylics, poly(methacrylates), atactic polystyrene, polycarbonate, styrene-acrylonitrile (SAN) and polyvinylchloride (PVC). A specific, and preferred, example is poly(methylmethacrylate). A blend of two or more glassy polymers may be used.

The second necessary component is a step-growth polymer. The term “step growth polymer” is a recognized term in the art having a specific meaning such as set forth on page 6 of Step-Growth Polymerization, “Organic Chemistry of Synthetic High Polymers,” by Robert W. Lenz, Interscience Publishers, 1967. Step-growth polymerization is a reaction in which each polymer chain grows at a relatively slow rate over a longer period of time compared to a chain-growth polymerization, and in which the initiation, propagation, and termination reactions are usually considered to be identical in both rate and mechanism. A further reference to step-growth polymers and polymerization is present in F. W. Billmeyer, Textbook of Polymer Science, 2^{nd} Edition, Wiley-Interscience, 1971, Chapter 8.

Examples of step-growth polymerization include a polycondensation equilibrium reaction and ring-opening polymerization. Step-growth polymers may be amorphous or semi-crystalline. Step-growth polymers include, but are not limited to, polyesters (such as poly(butyl terephthalate), poly(ethyl terephthalate), poly(propyl terephthalate), thermoplastic polyester elastomers (e.g., Hytrel®)), polyamides (such as nylon 6, nylon 6,6, and nylon 6,12), polyaramids, and polyketone. Preferred examples include poly(butyl terephthalate) and nylon 6,12. Optionally, a blend of two or more polymers may be used. It is understood that step-growth polymerization and the step-growth polymer formed thereby excludes chain growth polymerization and any resulting polymer.

The third necessary component is an oligomer or polymer which is miscible with the glassy polymer and capable of interacting with the step-growth polymer. As employed herein the term “miscible” means the oligomer or polymer will be miscible with the glassy polymer within the composition of the present invention. By “miscible” is meant a standard chemical definition namely capable of being and remaining mixed in all proportions. Exemplary reactive compatibilizers are epoxy polymers and styrene maleic anhydride (SMA).

The fourth necessary component is particulate filler. Examples of such fillers, well known to the art, are described in “Plastic Additives Handbook, 4th Edition” R. Gachter and H. Muller (eds.), P. P. Klemchuck (assoc. ed.) Hansen Publishers, New York 1993. Some representative fillers include alumina, alumina trihydrate (ATH), alumina monohydrate, aluminum hydroxide, aluminum oxide, aluminum sulfate, aluminum phosphate, aluminum silicate, Bayer hydrate, borosilicates, calcium sulfate, calcium silicate, calcium phosphate, calcium carbonate, calcium hydroxide, calcium oxide, apatite, glass bubbles, glass microspheres, glass fibers, glass beads, glass flakes, glass powder, glass spheres, barium carbonate, barium hydroxide, barium oxide, barium sulfate, barium phosphate, barium silicate, magnesium sulfate, magnesium silicate, magnesium phosphate, magnesium hydroxide, magnesium oxide, kaolin, montmorillonite, bentonite, pyrophyllite, mica, gypsum, silica (including sand), polymeric fiber, ceramic microspheres and ceramic particles, powder talc, titanium dioxide, diatomaceous earth, borax, organic filler such as ground soybean husks; wheat chaff; wood flour; straw; sawdust, or combinations thereof. A preferred filler is aluminum trihydrate due to an ability to retard burning.

The size of the particulate filler typically is not critical in the present invention and dependent on desired functional and aesthetic properties with the understanding that settling becomes more and more of a consideration as the size and concentration of the particles increases. Also it is well known in the art to employ particle sizes of different distributions which likewise are suitable in the present invention. Illustratively at least a portion of the particles will be present in a range from 1 to 500 microns (based on the largest dimension of the particle). A more preferred range is from 5 to 100 microns. However both smaller and larger particles may be employed.

For preferred compositions of the present invention the amounts of the four necessary components can be expressed in terms of percentage by weight of the overall composition (which includes other additives). Illustratively the following ranges are—for the glassy polymer 20 to 80 percent and more preferably 30 to 60 percent, for the step-growth polymer 5 to 25 percent and more preferably 10 to 20 percent, for the oligomer or polymer which is miscible with the glassy polymer 2 to 15 percent and more preferably 5 to 10 percent and for the particulate filler 7 to 65 percent and more preferably 20 to 45 percent.

For the above weight concentration of the particulate filler, it is apparent that the concentration can vary from a low to a high amount of filler. Without being bound to any theory, it is believed that a surface interaction takes place between the filler and with domains of the step-growth polymer. Such surface interaction can aid to making a final article with improved strength and toughness.

In a preferred embodiment of the invention a large amount of particulate filler is employed, i.e. at least 20 weight percent of the precursor composition and in many instances at least 45 weight percent. Consistent with the theory set forth above wherein a surface interaction takes place, it is considered that such interaction retards re-agglomeration of the particulate filler. Such retardation of re-agglomeration becomes more and more critical as the concentrations of step-growth polymer and particulate filler increases.

The use of a high concentration of filler becomes important such as for kitchen countertops where flame resistance is important. However it is understood that usefulness is present over the entire range of the four required components including a low concentration of filler.

Other ingredients are included in the present composition to enhance physical performance, improve processability, or adjust visual aesthetics. Impact modifiers, for example, elastomeric polymers such as graft copolymers of methyl methacrylate, styrene, and butadiene, copolymers of butyl acrylate and methyl acrylate or other well-known impact modifiers can be added to improve impact strength. Flame retardant additives such as brominated organics, halogenated hydrocarbons, mineral carbonates, hydrated minerals, and antimony oxide can be incorporated. Other flame retardants include carbon fiber and aramid fiber. Antioxidants (such as ternary or aromatic amines, Irganox® (a registered trademark of Ciba Geigy), and sodium hypophosphites), UV stabilizers (such as Tinuvin supplied by Ciba Geigy), stain-resistant agents (such as poly(tetrafluoroethylene) (e.g., Teflon® a trademark of DuPont), stearic acid, and zinc stearate), or combinations thereof. Optionally, alumina (Al2O3) may be added to improve resistance to marring. Fibers (e.g., glass, nylon, and carbon) can be added to improve mechanical properties.

The following examples in which parts and percentages are by weight, unless otherwise indicated, further illustrate the invention. The abbreviation “wt.” means -weight-.

### EXAMPLE 1

A filled polymer composition was prepared in sheets using a twin screw extruder by blending 27.7 wt. % of the glassy acrylic resin Plexiglas VS-100 (supplied by Arkema), 11.3 wt. % of the step-growth Nylon 6,12 resin Zytel® 158 (supplied by DuPont). The polymer resins were compatibilized by 8.0 wt. % Epon 1009F epoxy resin (supplied by Shell Chemicals). Cimbar PC (BaSO₄, supplied by Cimbar) was added at 45.0 wt. % and Elvaloy® 4170 (supplied by DuPont) was present at 8.0 wt. %. The material exhibited physical characteristics of a well-compatibilized blend, including good integrity and mechanical performance.

### EXAMPLE 2

A filled polymer composition was prepared by blending 33.6 wt. % of the glassy acrylic resin Plexiglas VS-100 (supplied by Arkema) and 15.0 wt. % of the step-growth high-temperature Nylon resin Zytel® HTN (supplied by DuPont). The polymer resins were compatibilized by 6.4 wt. % Dylark 323 (styrene-maleic anhydride triblock copolymer, supplied by NOVA Chemicals). Cimbar PC (BaSO₄, supplied by Cimbar) was added at 45.0 wt. %.

### EXAMPLE 3

A filled polymer composition was prepared by blending 15 wt. % of the glassy acrylic resin Plexiglas VO-45 (supplied by Arkema) and 30 wt. % of the step-growth Nylon 6,12 resin Zytel® 158 (supplied by DuPont). The polymer resins were compatibilized by 10 wt. % Dylark 378 (styrene-maleic anhydride triblock copolymer with impact-modifier, supplied by NOVA Chemicals). Blanc Fixe filler (BaSO₄, supplied by Polar Minerals) was added at 45 wt. %.

### EXAMPLE 4

A filled polymer composition was prepared by blending 24 wt. % of the glassy styrenic resin Styron 693 (supplied by Dow Plastics) and 24 wt. % of the step-growth polybutylterephthalate resin Crastin® 6129 (supplied by DuPont). The polymer resins were compatibilized by 7 wt. % Dylark 378 (styrene-maleic anhydride triblock copolymer with impact-modifier, supplied by NOVA Chemicals). Blanc Fixe filler (BaSO₄, supplied by Polar Minerals) was added at 45 wt. %.

### EXAMPLE 5

A filled polymer composition was prepared by blending 24 wt. % of the glassy styrenic resin Styron 693 (supplied by Dow Plastics) and 24 wt. % of the step-growth co-polyester resin Hytrel® 7246 (supplied by DuPont). The polymer resins were compatibilized by 7 wt. % Dylark 378 (styrene-maleic anhydride triblock copolymer with impact-modifier, supplied by NOVA Chemicals). Blanc Fixe filler (BaSO₄, supplied by Polar Minerals) was added at 45 wt. %.

### EXAMPLE 6

A filled polymer composition was prepared by blending 24 wt. % of the glassy polyvinylchloride resin Geon 8700x (supplied by Polyone) and 24 wt. % of the step-growth polybutylterephthalate resin Crastin® 6129 (supplied by DuPont). The polymer resins were compatibilized by 7 wt. % Dylark 378 (styrene-maleic anhydride triblock copolymer with impact-modifier, supplied by NOVA Chemicals). Blanc Fixe filler (BaSO₄, supplied by Polar Minerals) was added at 45 wt. %.

### EXAMPLE 7

A filled polymer composition was prepared by blending 6.9 wt. % of the glassy polycarbonate resin Calibre 200 (supplied by GE) and 27.5 wt. % of the step-growth polybutylterephthalate resin Crastin® 6129 (supplied by DuPont). The polymer resins were compatibilized by 20.6 wt. % Dylark 378 (styrene-maleic anhydride triblock copolymer with impact-modifier, supplied by NOVA Chemicals). Blanc Fixe filler (BaSO₄, supplied by Polar Minerals) was added at 45 wt. %.

### EXAMPLE 8

A filled polymer composition was prepared by blending 50.25 vol. % of the glassy polycarbonate resin Calibre 201 (supplied by GE) and 12.73 vol. % of the step-growth resin Crastin® 6129 (polybutyl terephthalate, supplied by DuPont). The polymer resins were compatibilized by 4.02 vol. % Epon 1009F (epoxy resin supplied by Shell Chemicals). A filler comprised of 33 vol. % barium sulfate (Cimbar PC, supplied by Cimbar Performance Minerals) was added.

### EXAMPLE 9

A filled polymer composition was prepared by blending 50.25 vol. % of the glassy polycarbonate resin Calibre 201 (supplied by GE) and 12.73 vol. % of the step-growth resin Crastin® 6129 (polybutyl terephthalate, supplied by DuPont). The polymer resins were compatibilized by 4.02 vol. % Epon 1009F (epoxy resin supplied by Shell Chemicals). The filler in this example was 33 vol. % Talc 9110 (supplied by Polar Minerals).

### EXAMPLE 10

A filled polymer composition was prepared by blending 50.25 vol. % of the glassy polycarbonate resin Calibre 201 (supplied by GE) and 12.73 vol. % of the step-growth resin Crastin® 6129 (polybutyl terephthalate, supplied by DuPont). The polymer resins were compatibilized by 4.02 vol. % Epon 1009F (epoxy resin supplied by Shell Chemicals). The filler for this example was 33 vol. % chopped strand fiberglass (Chopvantage 3540, supplied by PPG).

What is claimed is:

1. A precursor composition to formation of a solid composite comprises:
(a) a glassy polymer;
(b) a step-growth polymer;
(c) a polymer or oligomer which is miscible with the glassy polymer; and
(d) particulate filler.

2. The precursor composition of claim 1 which comprises by weight:
(a) 20 to 80 percent glassy polymer;
(b) 5 to 25 percent step-growth polymer;
(c) 2 to 15 percent polymer or oligomer; and
(d) 7 to 65 percent particulate filler.

3. The precursor composition of claim 2 which comprises by weight:
(a) 30 to 60 percent glassy polymer;
(b) 10 to 20 percent step-growth polymer;
(c) 5 to 10 percent polymer oligomer; and
(d) 20 to 45 percent particulate filler.

4. The precursor composition of claim 1, wherein the glassy polymer comprises acrylic, atactic polystyrene, polycarbonate, styrene-acrylonitile, polyvinylchloride or combinations thereof.

5. The precursor composition of claim 4, wherein the glassy polymer comprises poly(methylmethacrylate).

6. The precursor composition of claim 1, wherein the step-growth polymer comprises polyester, thermoplastic polyester elastomer, polyamide, polyaramid, polyketone or combinations thereof.

7. The precursor composition of claim 6, wherein the step-growth polymer comprises poly(butyl terephthalate) or nylon 6, 12.

8. The precursor composition of claim 1, wherein the polymer or oligomer comprises epoxy polymer or styrene-maleic anhydride.

9. The precursor composition of claim 1, wherein the filler is aluminum trihydrate.

10. A precursor composition to formation of a solid composite comprises:
(a) a glassy polymer;
(b) a step-growth polymer;
(c) a polymer or oligomer which is miscible with the glassy polymer; and
(d) particulate filler in an amount of 45 to 65 weight percent.

11. An article formed from the precursor composition of claim 1.

12. An article formed from the precursor composition of claim 10.
